(19) United States
(12) Patent Application Publication
(10) Pub. No.: US 2016/0182744 A1
(43) Pub. Date: Jun. 23, 2016

(54) PRINTING SYSTEM AND PRINTING INSTRUCTION APPARATUS

(71) Applicant: Panasonic Intellectual Property Management Co., Ltd., Osaka (JP)

(72) Inventors: Kunihiko Morota, Fukuoka (JP); Yasuaki Hara, Fukuoka (JP); Shougo Kimura, Fukuoka (JP); Masanobu Soejima, Saga (JP)

(21) Appl. No.: 14/970,206

(22) Filed: Dec. 15, 2015

(30) Foreign Application Priority Data
Dec. 22, 2014 (JP) 2014-259326

(51) Int. Cl. H04N 1/00; G06F 3/12

(52) U.S. Cl. CPC H04N 1/00204; G06F 3/1205; G06F 3/125; G06F 3/1256; G06F 3/1272; G06F 3/1286; H04N 2201/0094

(57) ABSTRACT

A printing instruction apparatus includes, a print data generator that generates first print data corresponding to document data of a first copy in document data and second print data corresponding to document data of second and subsequent copies in the document data, according to a print request for multiple copies of the document data, and a transmitter that transmits the generated first print data to the printing apparatus. A printing apparatus includes, a receptor that receives the transmitted first print data, a printer that performs printing according to the received first print data, and an operator that receives a print execution operation corresponding to a printed result according to the first print data. The transmitter transmits the generated second print data to the printing apparatus according to the print execution operation, and the printer performs printing according to the second print data.

### BACKGROUND OF THE INVENTION

1. Field of the Invention

The present invention relates to a printing system and a printing instruction apparatus for instructing printing of document data to a printing apparatus.

2. Description of the Related Art

In recent years, in order to effectively print document data, for example, collective handling of print data corresponding to documents, or printing with generation of the print data suitable for various print formats, has been performed.

For example, in a case where print data of a plurality of files in which a group ID is added to a header is transferred from a personal computer (PC) used by a user (for example, user A) to a printer, and print data in which a group ID is not added to a header is transferred from a PC used by another user (for example, user B) to the printer, according to a print control method described in Japanese Patent Unexamined Publication No. 1999-55496, even if print data of a plurality of files which is transferred from the PC of user B are mixed with print data of a plurality of files which is transferred from the PC of user A, a group ID is verified in printing, and print data having the same group ID is collectively printed.

In addition, in an information processing apparatus of Japanese Patent Unexamined Publication No. 1998-240464, in a case where the number of copies to be printed of print data is designated as two or more, if a file format is ‘partition’, print data files corresponding to the number of copies to be printed are transferred to a printer system by individually filing print data corresponding to the number of copies to be printed. In addition, the information processing apparatus generates a single print data file based on print data corresponding to the number of copies to be printed in a case where a file format is ‘package’, and transfers the generated file to a printer system.

Further, in a network printing apparatus of Japanese Patent Unexamined Publication No. 1997-212315, when a plurality of print data determined as a print target has been stored, even if description formats (for example, page description languages) of the respective print data are different from each other, a description format of each print data is converted into a predetermined format and the plurality of print data are converged into a single piece of print data, and printing corresponding to the single piece of print data is performed.

However, these techniques have been invented not considering proof print pertaining to a case where multiple copies of a document are printed (that is, print of a first copy of the document in order to check content in a case where the document is printed, followed by printing of second and subsequent copies of the document in a case where there is no problem in a user's check of the content of the printed result, for example). Therefore, there is a problem that it is difficult to efficiently perform the proof print when the document is printed.

### SUMMARY OF THE INVENTION

In order to solve the problems described above, an object of the present disclosure is to provide a printing system and a printing instruction apparatus that efficiently perform proof print when a document is printed and improve a user's convenience.

The present disclosure provides a printing system, including: a printing instruction apparatus; and a printing apparatus that is connected to the printing instruction apparatus. The printing instruction apparatus includes, a print data generator that generates first print data corresponding to document data of a first copy in document data and second print data corresponding to document data of second and subsequent copies in the document data, according to a print request for multiple copies of the document data, and a transmitter that transmits the generated first print data to the printing apparatus, the printing apparatus includes, a receptor that receives the transmitted first print data, a printer that performs printing according to the received first print data, and an operator that receives a print execution operation corresponding to a printed result according to the first print data, the transmitter transmits the generated second print data to the printing apparatus according to the print execution operation, and the printer performs printing according to the second print data which is transmitted from the transmitter.

In addition, the present disclosure provides a printing instruction apparatus which is connected to a printing apparatus, comprising: a print data generator that generates first print data corresponding to document data of a first copy in document data and second print data corresponding to document data of second and subsequent copies in the document data, according to a print request for multiple copies of the document data; and a transmitter that transmits the generated first print data to the printing apparatus, the transmitter transmits the generated second print data to the printing apparatus and instructs printing of the second print data in the printing apparatus, according to a print execution operation corresponding to a printed result in the printing apparatus according to the first print data.

According to the present disclosure, in a case where a document is printed, it is possible to efficiently perform proof print and improve a user's convenience.

### BRIEF DESCRIPTION OF DRAWINGS

FIG. 1 is a diagram illustrating an example of a system configuration of a printing system according to a present embodiment;

FIG. 2 is a block diagram illustrating an example of an internal structure of a multifunction product according to the present embodiment;

FIG. 3 is an explanatory diagram illustrating an example of signaling in proof print between a PC and the multifunction product according to the present embodiment;

FIG. 4 is a diagram illustrating a first example of a setting screen of the proof print in the PC according to the present embodiment;

FIG. 5A is a diagram illustrating a second example of the setting screen of the proof print in the PC according to the present embodiment, and FIG. 5B is a diagram illustrating an example of a task tray which is displayed on a display of the PC according to the present embodiment;

FIG. 6 is a diagram illustrating an example of a menu screen of an application relating to a multifunction product which is displayed on a display of the PC according to the present embodiment;

FIG. 7A is a diagram illustrating a first example of a management screen relating to proof print of a print job manager, and FIG. 7B is a diagram illustrating a second example of the management screen relating to the proof print of the print job manager;

FIG. 8A is a schematic diagram illustrating a generation example of a file of print job data in proof print according to the present embodiment, and FIG. 8B is a schematic diagram illustrating a generation example of a file of print job data in a case of printing a document file in the related art; and

FIG. 9 is a sequence diagram explaining an example of operation procedures of proof print between a PC and a multifunction product according to the present embodiment in detail.

### DETAILED DESCRIPTION OF THE PREFERRED EMBODIMENT

Hereinafter, an embodiment (hereinafter, “the present embodiment”) specifically disclosing a printing system and a printing instruction apparatus according to the present invention will be described with reference to the drawings. In the present embodiment, for example, a general-purpose PC will be described as the printing instruction apparatus according to the present invention, and a configuration including a PC and a multifunction product as an example of a printing apparatus will be described as a printing system according to the present invention.

In the printing system according to the present embodiment, a printing instruction apparatus (for example, a PC, a portable terminal, or the like) is connected to a printing apparatus (for example, a multifunction product, a printer, or the like), and the printing instruction apparatus generates first print data corresponding to document data of a first copy in the document data and second print data corresponding to document data of second and subsequent copies in the document data, according to a print request (that is, a request for proof print for outputting multiple copies of a document with the multiple pages) for the multiple copies of the document data, and transmits the first print data to the printing apparatus. The printing apparatus receives the first print data transmitted from the printing instruction apparatus, and performs printing according to the first print data. If it is determined that there is no problem in the content of a printed result by a user who checks the printed result according to the first print data, printing of the second print data is instructed to the printing apparatus according to a user's operation. The printing instruction apparatus transmits the second print data to the printing apparatus according to the instruction of printing on the printing apparatus, and the printing apparatus performs printing corresponding to the second print data transmitted from the printing instruction apparatus.

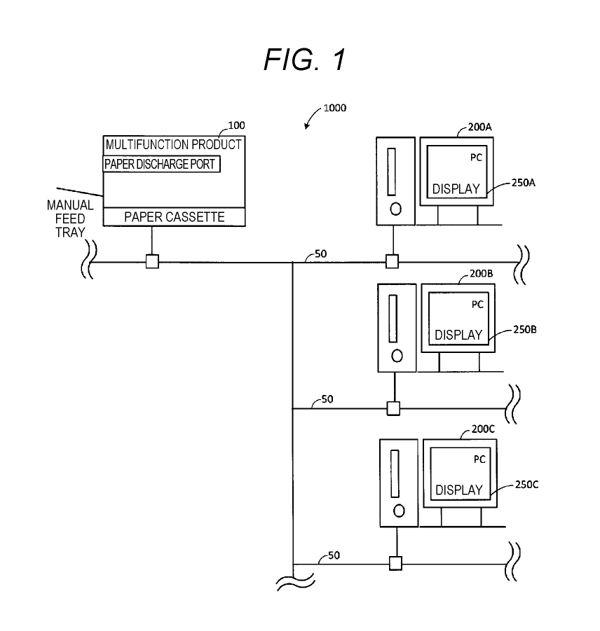

FIG. 1 is a diagram illustrating an example of a system configuration of printing system 1000 according to the present embodiment. In FIG. 1, for example, three PCs 200A, 200B, and 200C are connected to multifunction product 100. However, the number of PCs is not limited to three. In addition, in FIG. 1, multifunction product 100 and plural PCs 200A, 200B, and 200C are connected with each other through network 50. However, it is possible to implement a plurality of multifunction products 100, and connect single multifunction product 100 and single PC 200A through network 50, a universal serial bus (USB), Bluetooth (registered trademark), or the like.

Multifunction product 100 and plural PCs 200A, 200B, and 200C are installed in, for example, an office, a store, or a house. For example, multifunction product 100 installed at a predetermined area in an office is shared by PCs (for example, PCs 200A, 200B, and 200C) which are used by an unspecified number of users (employees) in the office, and an image forming function thereof (for example, printer function, copying function, facsimile function, or image scanner function) is used as necessary.

Multifunction product 100 is a multi function printer (MFP) apparatus having functions of, for example, a printer, a copier, a facsimile, and an image scanner. If print job data transmitted from PCs 200A, 200B, and 200C that are connected through network 50 is received, multifunction product 100 forms image data corresponding to print job data using a predetermined method, prints the formed image data on a predetermined medium (for example, paper for printing) set in a paper cassette or a manual feed tray, and outputs the printed result (that is, a print-out) through a paper discharge port.

In the present embodiment, since configurations and operations of PCs 200A, 200B, and 200C are the same, hereinafter, PC 200A is described as an example in order to simplify description. Network 50 may be a wired network (for example, intranet such as local area network (LAN) or internet) or a wireless network (for example, wireless LAN or wireless wide area network (WAN)). In addition, single multifunction product 100 and single PC 200A may be connected with each other through USB or Bluetooth (registered trademark).

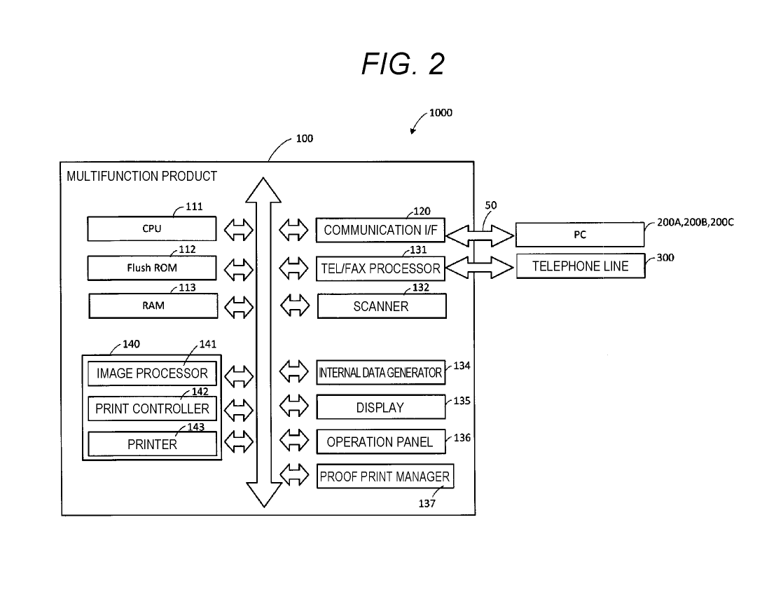

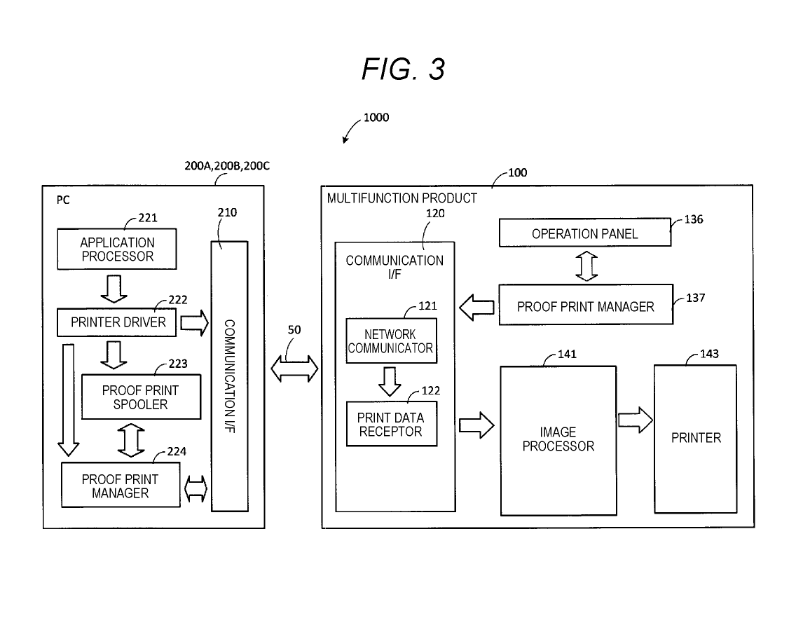

FIG. 2 is a block diagram illustrating an example of an internal configuration of multifunction product 100 according to the present embodiment. FIG. 3 is an explanatory diagram illustrating an example of signaling in proof print between PCs 200A, 200B, and 200C which are personal computers and multifunction product 100 according to the present embodiment.

Multifunction product 100 illustrated in FIG. 2 is configured with central processing unit (CPU) 111, flush read only memory (Flush ROM) 112, random access memory (RAM) 113, communication I/F 120, TEL/FAX processor 131, scanner 132, internal data generator 134, display 135, operation panel 136, proof print manager 137, and print unit 140. Print unit 140 is configured with image processor 141, print controller 142, and printer 143.

In FIG. 3, PCs 200A, 200B, and 200C are configured with communication I/F 210, application processor 221, printer driver 222, proof print spooler 223, and proof print manager 224. In FIG. 3, among sections of multifunction product 100 illustrated in FIG. 2, for the convenience of explanation, only communication I/F 120, operation panel 136, proof print manager 137, image processor 141, and printer 143 are illustrated and the illustration of other sections is omitted.

CPU 111, for example, realizes various functions for controlling entire multifunction product 100 by reading and executing a program and data which are stored in Flush ROM 112 in advance. In FIG. 2, CPU 111 is connected to respective sections through an internal bus.

Flush ROM 112 stores various types of programs and data (for example, programs executed by CPU 111 and various types of data required for running the programs). For example, CPU 111 writes data to Flush ROM 112 and reads data which is stored in Flush ROM 112. In addition, the data stored in Flush ROM 112 do not get erased even if the power source of multifunction product 100 is OFF.

RAM 113 stores various types of data. For example, CPU 111 writes data to RAM 113 and reads data which is stored in RAM 113. The data stored in RAM 113 get erased if the power source of multifunction product 100 is OFF. For this reason, RAM 113 is used for storing data which is temporarily generated.

Communication I/F 120 provides a function for connecting multifunction product 100 to another apparatus (for example, PC 200A) through network 50. Communication I/F 120, as described in FIG. 3, includes network communicator 121 and print data receptor 122. For example, communication I/F 120 performs communication using a Transmission Control Protocol (TCP) and an Internet Protocol (IP).

Network communicator 121 controls communication through network 50, receives, for example, a print request in a case where there is the print request from PC 200A, and establishes a communication session with PC 200A in network 50. Information of the communication session according to the print request is registered in communication I/F 120.

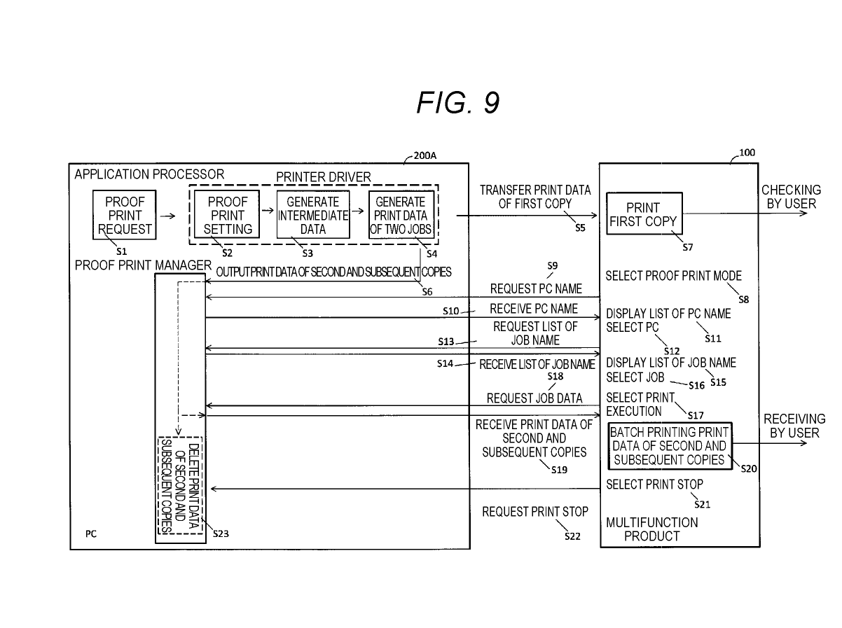

For example, the print request may include a print request for normal print (that is, for example, print of one copy or more in a document of one page or more in printing other than proof print) other than a print request for proof print. A communication session is established between PC 200A and multifunction product 100 in network 50 by a print request for the proof print being made by application processor 221 of PC 200A according to a user's operation on PC 200A. Details of this will be described later with reference to FIG. 9.

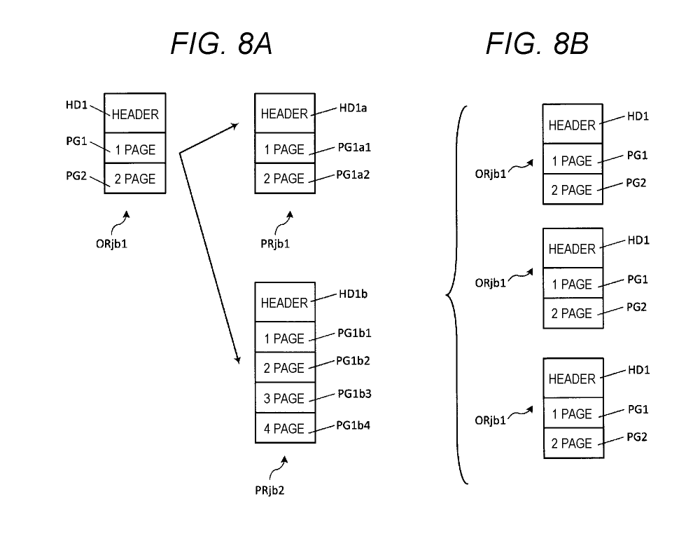

Print data receptor 122 as an example of a receptor receives first print job data PRjb1 and second print job data PRjb2 (see FIG. 8A) transmitted from PC 200A in a state where a communication session is established between PC 200A and multifunction product 100. First print job data PRjb1 and second print job data PRjb2 are generated from PC 200A, and are data required for printing in printer 143 of multifunction product 100. Details of this will be described later with reference to FIG. 8A. For example, in a case where a print target is documentation data, information of content of characters, sizes of characters, fonts of characters, and arrangement positions of characters is stored in a header of the print job data.

TEL/FAX processor 131 provides a phone function and a facsimile function of multifunction product 100. TEL/FAX processor 131, for example, has a function of a modulator-demodulator (modem) for modulating or demodulating data communicated through telephone line 300 and a function of controlling a communication protocol.

For example, scanner 132 optically reads images recorded on paper, and generates and outputs image data.

Internal data generator 134 generates various types of internal data required for processes to be executed by CPU 111 in multifunction product 100. For example, internal data generator 134 generates a setting menu list of a print function, a phone book list, a FAX transmission history, or the like.

Display 135, for example, is configured using a liquid crystal display and has a screen capable of displaying visible information (for example, characters, symbols, and images).

Operation panel 136 as an example of an operator includes buttons, keys, and a combination thereof capable of receiving a user's operation. Operation panel 136, for example, includes a numeric keypad for inputting a predetermined number, a personal identification number, or a password for each user, a cursor moving key for selecting PC 200A as a request source of proof print or a print job to be subjected to the proof print, and an enter key. Buttons and keys of operation panel 136 may be configured by hardware or software.

Proof print manager 137 is associated with proof print manager 224 of PC 200A, and manages executing and stopping of proof print of a document with multiple pages. Proof print manager 137 requests the name of a PC (for example, PC 200A) which performs a request for the proof print or a name list of a print job of the proof print to PC 200A, according to, for example, a user's operation on operation panel 136, and obtains the name of PC 200A or the name list of print job of proof print.

Image processor 141 processes print job data (for example, first print job data PRjb1 and second print job data PRjb2). The processing of print data includes translation of print language and rasterization processing, for example. Image processor 141 expands, for example, print job data received by print data receptor 122, and converts the expanded print job data into bit map data similar to images to be a print target. Image processor 141, for example, decodes various types of control codes or character codes by extracting the codes from print job data generated according to a format that is determined in advance. Image processor 141, for example, performs processes of positioning, rotation, and enlargement or reduction of images according to the control codes. Image processor 141, for example, expands character codes to corresponding character patterns, and generates image data for printing.

Printer 143 receives image data for printing generated from image processor 141, and prints the received image data on a predetermined medium (for example, paper). A printing method for printer 143 includes various known methods.

For example, printer 143 charges respective regions of a photosensitive member formed in a drum shape in advance. Printer 143 turns on and off output of a laser light source according to data of each of pixel positions of images to be printed. Printer 143 adsorbs toner to electrostatic latent images which are formed on a surface of the photosensitive member by writing with a laser beam on the respective regions of the photosensitive member in accordance with rotation positions of the photosensitive member and scan positions of the laser light source, and visualizes latent images using the toner. Printer 143, for example, superimposes papers on a surface of the photosensitive member and transfers and fixes toner images of the photosensitive member to the papers.

Printer controller 142 controls printing by printer 143. Printer controller 142 controls a timing for controlling respective sections relating to the printing and on and off of the respective sections so that the rotation positions of the photosensitive member, scan positions of the laser light source, and respective pixel positions correspond to each other. Printer controller 142, for example, controls feeding of papers, and the transferring and fixing of the images.

Although description is omitted in FIG. 3, PCs 200A, 200B, and 200C include, for example, a hardware having a CPU and a storage, and an Operating System (OS) for performing a basic control. The OS, for example, provides a function, to printer driver 222, which spools (stores) print job data of normal print or proof print to proof print spooler 223.

Communication I/F 210 provides a communication function that connects PCs 200A, 200B, and 200C with network 50. PCs 200A, 200B, and 200C are connected to multifunction product 100 through communication I/F 210 and network 50. In addition, communication I/F 210 as an example of a transmitter transmits, for example, a print request and print job data corresponding to the print request to multifunction product 100, and controls the transmission of the print job data. In the present embodiment, first print job data PRjb1 to be described later is transmitted to multifunction product 100, after being generated from printer driver 222 according to a request for proof print from application processor 221. Second print job data PRjb2 is transmitted according to a transmission request from multifunction product 100.

Application processor 221 processes various types of application programs which are installed in PC 200A. The various types of application programs include, for example, an application for generating documents, tables, and images. When, for example, printing of documents is instructed according to a user's operation, application processor 221 outputs document data as a print target to printer driver 222.

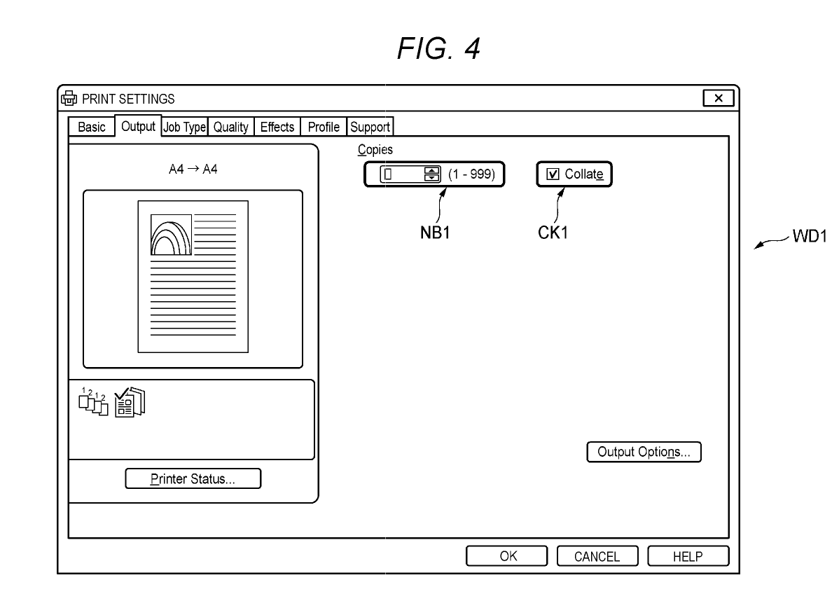

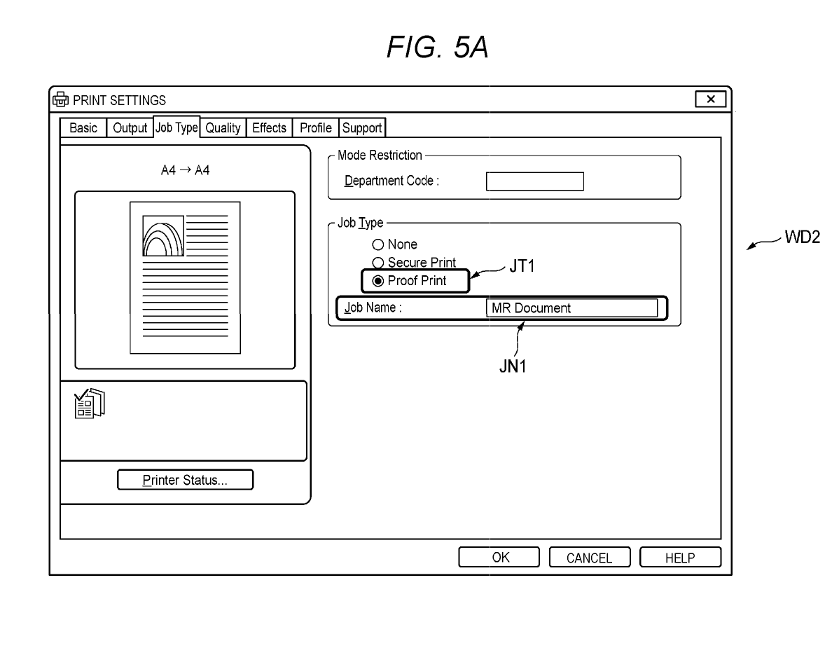

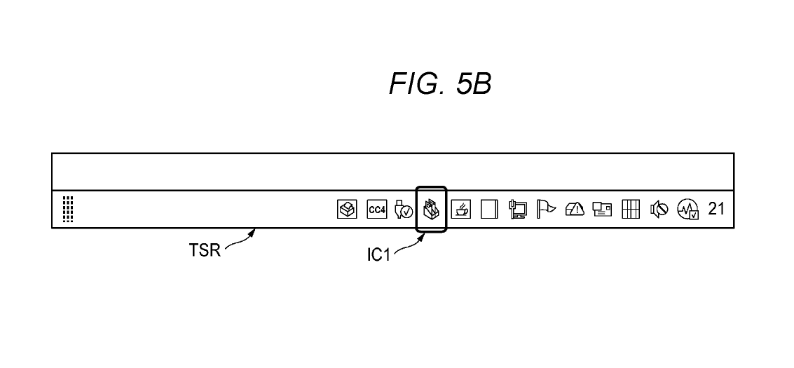

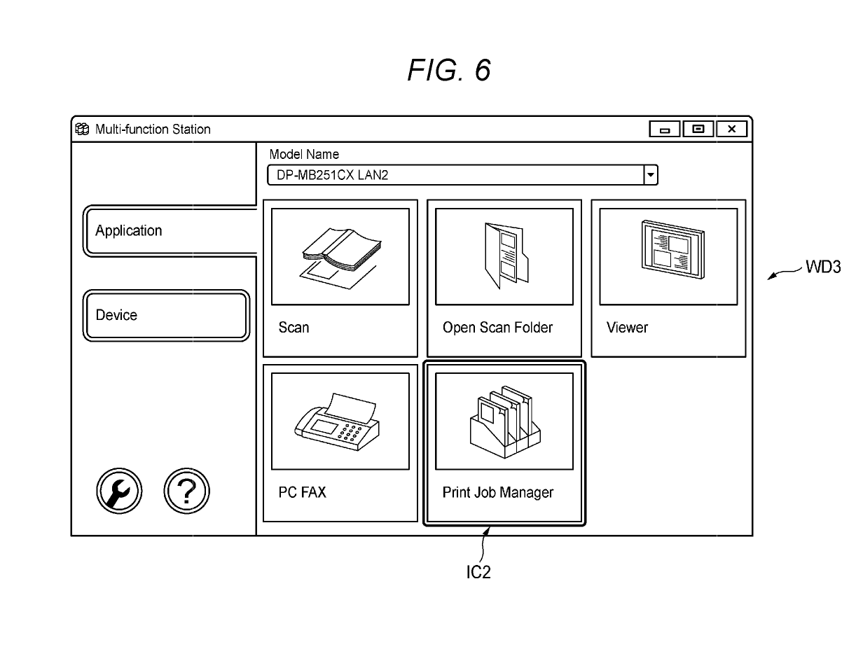

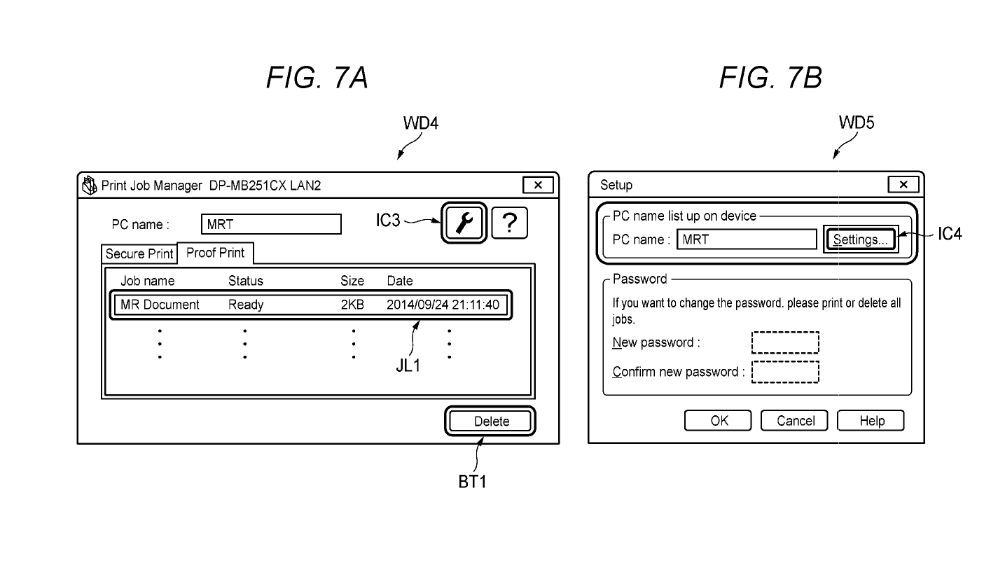

Printer driver 222 performs various controls relating to printing between PC 200A and multifunction product 100. Printer driver 222, for example, displays a screen (for example, see FIG. 4, FIG. 5A, FIG. 6, and FIGS. 7A and 7B) for setting or management to be described later on display 250A, and performs a setting control according to a user's operation on various screens.

In addition, printer driver 222 as an example of a print data generator generates print job data relating to normal print or proof print by using document data output from, for example, application processor 221, after performing various settings relating to printing according to user's operations. Here, the print job data will be described with reference to FIGS. 8A and 8B in detail. FIG. 8A is a schematic diagram illustrating a generation example of a file of print job data in proof print according to the present embodiment. FIG. 8B is a schematic diagram illustrating a generation example of a file of print job data in a case of printing a document file in the related art. In FIGS. 8A and 8B, for example, a case where proof print is required in which the number of documents, each of which has two pages, is set to three will be described as an example.

In FIG. 8A, if proof print is requested by application processor 221, printer driver 222 generates original print job data ORjb1 as intermediate data based on document data with multiple pages (for example, two pages) to be a target of the proof print and various types of setting information (for example, see FIG. 4 and FIG. 5A) of proof print. Original print job data ORjb1 includes header HD1, document data PG1 of a first page, and document data PG2 of a second page. Header HD1 stores various types of information (for example, the number of pages) relating to a document with multiple pages to be a target of the proof print.

If original print job data ORjb1 is generated, printer driver 222 generates first print job data PRjb1 and second print job data PRjb2 based on various types of setting information of the proof print. First print job data PRjb1 includes document data PG1a1 of a first page in a first copy, document data PG1a2 of a second page in the first copy, and header HD1a. Similarly, second print job data PRjb2 includes document data PG1b1 of a first page in a second copy, document data PG1b2 of a second page in the second copy, document data PG1b3 of a first page in a third copy, document data PG1b4 of a second page in the third copy, and header HD1b.

In addition, when first print job data PRjb1 and second print job data PRjb2 are generated, printer driver 222 modifies various types of information (for example, the number of pages), which are stored in header HD1 of original print job data ORjb1, in header HD1a according to first print job data PRjb1 and in header HD1b according to second print job data PRjb2. For example, the number of pages stored in header HD1a is modified to 2 and the number of pages stored in header HD1b is modified to 4.

Meanwhile, in the related art illustrated in FIG. 8B, when a printing in which the number of a document with two pages is set to three is performed, original print job data ORjb1 illustrated in FIG. 8A is generated for each copy of a document to be a print target without generating first print job data PRjb1 and second print job data PRjb2 according to the present embodiment. That is, three pieces of original print job data ORjb1 are generated.

Accordingly, when proof print according to the present embodiment is performed, a user checks the printed result (a print-out) according to original print job data ORjb1 of a first copy. In a case where it is determined that there is no problem in the content of the printed result, it is necessary for the user to perform operations of respective print instructions with respect to original print job data ORjb1 of a second copy and original print job data ORjb1 of a third copy, and thus the user's operation is complicated. In addition, in a case where it is determined that there is a problem (for example, there is a clerical error) in the content of the printed result (a print-out) of printing according to original print job data ORjb1 of a first copy, it is necessary for the user to perform an operation of a print stop instruction of each printing with respect to original print job data ORjb1 of a second copy and original print job data ORjb1 of a third copy. Accordingly, since a user's operation is required for each of original print job data ORjb1, the user's operation becomes complicated.

Meanwhile, in the present embodiment, since second print job data PRjb2 in which document data of second and subsequent copies is included in a batch is generated, the user may perform an operation of a print instruction alone with respect to second print job data PRjb2 in a case where it is determined by a user that there is no problem in the content of a printed result (a print-out) of first print job data PRjb1 of a first copy, and similarly, the user may perform an operation of a print stop instruction alone in a case of stop of the print (see FIG. 7A). That is, in a case where the print is performed or stopped, the degree of complexity of user's operation is considerably reduced as compared with the related art illustrated in FIG. 8B. FIG. 7A is a diagram illustrating a first example of a management screen relating to proof print of a print job manager. In addition, a screen as illustrated in FIG. 7A is displayed when an icon IC2 of “Print Job Manager” of an application menu screen WD3 relating to multifunction product 100 illustrated in FIG. 6 is clicked. FIG. 6 is a diagram illustrating an example of an application menu screen relating to multifunction product 100 displayed on display 250A of PC 200A according to the present embodiment.

If icon IC3 is clicked in management screen WD4 illustrated in FIG. 7A, management screen WD5 illustrated in FIG. 7B is displayed, and the name of PC 200A as a request resource of proof print can be set according to a user's operation with respect to management screen WD5. FIG. 7B is a diagram illustrating a second example of a management screen relating to proof print of a print job manager. FIG. 7B illustrates that the name of PC 200A is set to the “MRT” by inputting “MRT” as the name of PC 200A according to the click of icon IC4.

In addition, in FIG. 7A, the name of PC 200A set in a management screen WD5 illustrated in FIG. 7B is displayed, and, if the tab of the “Proof Print” is selected, record JL1 of a print job relating to second print job data PRjb2 is displayed which is generated by printer driver 222 according to a request for proof print. For example, if “Delete” button BT1 is selected in a state where record JL1 is selected according to a user's operation, proof print manager 224 deletes second print job data PRjb2 corresponding to record JL1. That is, the proof print corresponding to second print job data PRjb2 is stopped.

Proof print spooler 223 as an example of a storage, for example, temporarily stores (spools) print job data generated from printer driver 222.

Proof print manager 224 is associated with proof print manager 137 of multifunction product 100, and manages execution of the proof print of a document with multiple pages or a stoppage of the proof print. Whether proof print or normal print is set is designated, for example, according to a print request output from application processor 221. Proof print manager 224 receives setting information relating to the proof print set in printer driver 222.

In addition, proof print manager 224, for example, holds authentication information (for example, personal identification number or password) assigned to a user, and identification information (for example, IP address or media access control (MAC) address) assigned to PCs 200A, 200B, and 200C. Proof print manager 224 may communicate with multifunction product 100 and may transmit information (for example, authentication information or identification information of PC 200A) which is held by proof print manager 224.

In addition, proof print manager 224 holds print job information according to a print request. The print job information, for example, includes information of the name of a file including document data as a print target and information of a time at which proof print is requested.

In addition, when a user determines that there is a problem in the content in a printed result (a print-out) according to first print job data PRjb1 in the proof print which prints multiple copies of a document with multiple pages, proof print manager 224 as an example of print data controller deletes second print job data PRjb2 from proof print spooler 223 according to a user's operation on multifunction product 100.

Next, operation procedures of proof print in printing system 1000 according to the present embodiment will be described with reference to FIG. 4, FIGS. 5A and 5B, and FIG. 9. FIG. 4 is a diagram illustrating a first example of a setting screen of proof print in PC 200A according to the present embodiment. FIG. 5A is a diagram illustrating a second example of a setting screen of proof print in PC 200A according to the present embodiment. FIG. 5B is a diagram illustrating an example of task tray TSR displayed on display 250A of PC 200A according to the present embodiment. FIG. 9 is a sequence diagram explaining an example of an operation procedure of proof print between PC 200A and multifunction product 100 according to the present embodiment in detail.

In FIG. 9, if proof print is requested by a user's operation (S1), application processor 221 outputs document data with multiple pages (for example, two pages) to be a target of the proof print to printer driver 222. If the document data to be a target of the proof print is received from application processor 221, printer driver 222 generates screen WD1 (see FIG. 4) or screen WD2 (see FIG. 5A) relating to various settings of the proof print, and displays the generated screen on display 250A. According to a user's operation on screen WD1 or screen WD2 displayed on display 250A, various settings relating to the proof print are performed (S2).

For example, the number of print copies (that is, the number of print copies of a document with multiple pages which are included in second print job data PRjb2 illustrated in FIG. 8A) which are required for printing documents with multiple pages is set in an input field NB1, and, a check is set in “Collate” field CK1 that designates print for each copy in screen WD1 illustrated in FIG. 4 according to a user's operation. Accordingly, it is necessary to set the check in “Collate” field CK1 in the proof print.

In addition, in screen WD2 illustrated in FIG. 5A, a specification field JT1 of the “Proof Print” is set among types of print (for example, one of normal print illustrated by “None”, secure print illustrated by “Secure Print”, and proof print illustrated by “Proof Print”) according to a user's operation, and the job name (Job Name, for example, “MR Document”) of printing of “Proof Print” which is set is input.

Printer driver 222 generates original print job data ORjb1 as intermediate data based on document data with multiple pages (for example, two pages) to be a target of the proof print and various types of setting information (for example, see FIG. 4 and FIG. 5A) of proof print (S3).

Furthermore, if original print job data ORjb1 is generated, printer driver 222 generates first print job data PRjb1 and second print job data PRjb2 based on the various types of setting information of the proof print (S4). In a case where proof print is required in which three copies of a document with two pages are set is illustrated, the description on first print job data PRjb1 and second print job data PRjb2 is omitted because the same content is described with reference to FIG. 8A.

Printer driver 222 outputs first print job data PRjb1 to communication I/F 210. With this, communication I/F 210 transmits (transfers) first print job data PRjb1 output from printer driver 222 to multifunction product 100 (S5). In addition, printer driver 222 outputs second print job data PRjb2 to proof print manager 224 (S6). Printer driver 222 may store second print job data PRjb2 in proof print spooler 223.

In a case where various types of settings of proof print are performed by a user's operation in step S2, as described in FIG. 5B, printer driver 222 displays icon IC1, which indicates that the request for the proof print is made, in task tray TSR displayed, for example, at a lower end of display 250A. With this, whenever there is a request for the proof print, printer driver 222 generates original print job data ORjb1, and thus it is possible for a user to easily grasp by icon IC1 being displayed on display 250A that original job data ORjb1 of the proof print is generated (in other words, a setting of the proof print is made).

In multifunction product 100, communication I/F 120 receives first print job data PRjb1 transmitted from communication I/F 210, and outputs the received data to printer 143 through image processor 141. Printer 143 performs printing according to first print job data PRjb1 (S7). That is, a first copy of a document with multiple pages to be a target of the proof print, is printed. A print-out of the first copy is provided for checking of content by a user.

In a case where it is determined that there is no problem in the content of a print-out of the first copy by a user's check, a proof print mode is selected with respect to multifunction product 100 by a user's operation on operation panel 136 (S8). If the proof print mode is selected, proof print manager 137 transmits a request for the name of PC 200A as a request resource of the proof print to PC 200A through communication I/F 120 (S9).

Proof print manager 224 receives the request for name of PC 200A as the request resource of the proof print transmitted from multifunction product 100 through communication IT 210, acquires information relating to the name (or an IP address of PC 200A) of PC 200A as a response according to the request, and transmits the acquired result to multifunction product 100 through communication IT 210. Proof print manager 137 receives information relating to the name of PC 200A transmitted from PC 200A through communication I/F 120 (S10).

The proof print manager 137 acquires the information relating to the name of PC 200A through communication I/F 120, and displays the acquired result on display 135. With this, a list of the name of PCs which request the proof print is displayed on display 135 (S11). If one of PCs that request the proof print desired by a user is selected according to a user's operation on operation panel 136 (S12), proof print manager 137 transmits a request for a print job list of proof print to PC 200A through communication I/F 120 (S13).

Proof print manager 224 receives the request for a print job list of proof print, which is transmitted from multifunction product 100, through communication I/F 210, acquires a print job list of proof print as a response according to the request for print job list, and transmits the acquired result to multifunction product 100 through communication I/F 210. Proof print manager 137 receives a print job list of proof print, which is transmitted from PC 200A, through communication I/F 120 (S14).

Proof print manager 137 acquires a print job list of proof print through communication I/F 120 and displays the acquired result on display 135. With this, the print job list of proof print is displayed on display 135 (S15). According to a user's operation on operation panel 136, a record for any one of print jobs of proof print desired by a user is selected (S16). Further, if an execution instruction of proof print with respect to the selected record is selected (S17), proof print manager 137 transmits a request for data (that is, second print job data PRjb2) corresponding to a print job of proof print to be a target of the execution instruction to PC 200A through communication I/F 120 (S18).

Proof print manager 224 receives the request for data corresponding to a print job of proof print, which is transmitted from multifunction product 100, through communication I/F 210, reads and acquires print job data (that is, second print job data PRjb2) of proof print from proof print spooler 223 as a response according to the request, and transmits the acquired data to multifunction product 100 through communication I/F 210. Proof print manager 137 receives second print job data PRjb2, which is transmitted from PC 200A, through communication I/F 120 (S19).

In multifunction product 100, communication I/F 120 receives second print job data PRjb2, which is transmitted from communication I/F 210, and outputs the received data to printer 143 through image processor 141. In printer 143, printing is performed according to second print job data PRjb2 (S20). That is, document data of second and subsequent copies of a document with multiple pages to be a target of the proof print is printed.

Meanwhile, according to a user's operation on operation panel 136, if a record for any one of print jobs of the proof print desired by the user is selected (S16), and then a print stop instruction of proof print with respect to the selected record is selected (S21), proof print manager 137 transmits a request for the print stop to PC 200A through communication I/F 120 (S22). In addition, the print stop instruction of proof print with respect to the record, as described above using FIG. 7A, can be executed by PC 200A.

Proof print manager 137 acquires a stop request of the proof print of the print job data (that is, second print job data PRjb2) of the proof print through communication I/F 120, and deletes second print job data PRjb2 (S23).

As described above, in printing system 1000 according to the present embodiment, according to a print request (in other words, proof print for outputting multiple copies of a document with multiple pages) for multiple copies of document data, PC 200A generates first print job data PRjb1 corresponding to document data of a first copy and second print job data PRjb2 corresponding to document data of second and subsequent copies, and transmits first print job data PRjb1 to multifunction product 100. If first print job data PRjb1 transmitted from PC 200A is received, multifunction product 100 performs printing according to first print job data PRjb1. In addition, if a user determines that there are no problems in the content of the print-out by checking the printed result (that is, a print-out of document data of a first copy) according to first print job data PRjb1, a print execution operation of document data of second and subsequent copies is input to multifunction product 100. According to the print execution operation, PC 200A transmits second print job data PRjb2 to multifunction product 100. Multifunction product 100 performs printing corresponding to second print job data PRjb2.

That is, in a case where a document is printed, printing system 1000 individually manages first print job data PRjb1 corresponding to document data of a first copy and second print job data PRjb2 corresponding to document data of second and subsequent copies. In addition, printing system 1000 performs printing of a document of a first copy before performing printing of the document of second and subsequent copies, and, in a case where a user determines that there are no problems in a print-out of the document of the first copy, printing system 1000 performs printing of a document of second and subsequent copies by a user's simple operation with respect to multifunction product 100. Accordingly, in a case where multiple copies of a document are printed, since printing system 1000 can efficiently perform so-called proof print, the convenience of a user is thereby improved.

In addition, in printing system 1000, if a user determines that there is a problem (for example, there is a clerical error or there is no figure, a page, text, or a combination thereof, which is necessary) in the content of a print-out after checking a printed result according to first print job data PRjb1, a print stop operation of document data of second and subsequent copies is input to multifunction product 100 or PC 200A. PC 200A deletes second print job data PRjb2 according to the print stop operation.

With this, in printing system 1000, without the user performing complicated operations to individually delete print job data (see FIG. 8B) generated for each copy of document data of second and subsequent copies as in the related art, since second print job data PRjb2 corresponding to document data of second and subsequent copies can be deleted by a user performing a simple print stop operation on multifunction product 100, it is possible to easily stop printing of a document of second and subsequent copies.

In addition, in printing system 1000, PC 200A generates at least one print job corresponding to a request for proof print, and displays the generated print job in display 250A. With this, whenever there is a request for the proof print, it is possible to allow a user to visually confirm a list of print job data in display 250A by generating the print job data, according to printing system 1000.

In addition, in printing system 1000, PC 200A generates at least one original print job data ORjb1 corresponding to the request for proof print, and displays a predetermined icon IC1 indicating that original print job data ORjb1 is generated, in display 250A. With this, in printing system 1000, original print job data ORjb1 is generated whenever there is a request for the proof print, and thus it is possible for a user to simply grasp that original print job data ORjb1 of proof print is generated by icon IC1 being displayed on display 250A. Accordingly, it is possible to remind the user that there is still a target of the proof print.

In addition, in printing system 1000, PC 200A stores second print job data PRjb2 corresponding to document data of second and subsequent copies in proof print spooler 223. Accordingly, printing system 1000 can individually manage second print job data PRjb2 by storing second print job data PRjb2 of PC 200A in proof print spooler 223 whenever there is a request for the proof print.

In addition, according to a request for printing (in other words, proof print for outputting multiple copies of a document with multiple pages) of multiple copies of document data, PC 200A according to the present embodiment generates first print job data PRjb1 corresponding to document data of a first copy and second print job data PRjb2 corresponding to document data of second and subsequent copies, and transmits first print job data PRjb1 to multifunction product 100. Further, if a user determines that there are no problems in the content of a print-out after checking a printed result (that is, a print-out of document data of a first copy) according to first print job data PRjb1, PC 200A transmits second print job data PRjb2 to multifunction product 100 according to a print execution operation of document data of second and subsequent copies, and instructs execution of printing according to second print job data PRjb2.

That is, in a case where a document is printed, PC 200A individually manages first print job data PRjb1 corresponding to document data of a first copy and second print job data PRjb2 corresponding to document data of second and subsequent copies. In addition, before instructing execution of printing of a document of second and subsequent copies to multifunction product 100, PC 200A instructs execution of the printing of the document of the first copy to multifunction product 100. Furthermore, in a case where a user determines that there are no problems in a print-out of a document of a first copy, a user instructs printing of the document of second and subsequent copies with a simple operation with respect to multifunction product 100. Accordingly, in a case where multiple copies of a document are printed by multifunction product 100, since PC 200A as an example of a printing instruction apparatus can efficiently perform so-called proof print, it is possible to improve the convenience of a user.

While various embodiments have been described above with reference to the drawings, it is a matter of course that the present disclosure is not limited thereto. It is clear that the skilled in the art can conceive various changes and modifications within the scope described in the claims, and it is also understood that these changes and modifications fall within the technical scope of the present disclosure.

What is claimed is:

1. A printing system, comprising:
a printing instruction apparatus; and
a printing apparatus that is connected to the printing instruction apparatus,
wherein the printing instruction apparatus includes,
a print data generator that generates first print data corresponding to document data of a first copy in document data and second print data corresponding to document data of second and subsequent copies in the document data, according to a print request for multiple copies of the document data, and
a transmitter that transmits the generated first print data to the printing apparatus,
wherein the printing apparatus includes,
a receptor that receives the transmitted first print data,
a printer that performs printing according to the received first print data, and
an operator that receives a print execution operation corresponding to the printed result according to the first print data,
wherein the transmitter transmits the generated second print data to the printing apparatus according to the print execution operation, and
wherein the printer performs printing according to the second print data which is transmitted from the transmitter.

2. The printing system of claim 1,
wherein the printing instruction apparatus further includes
a print data controller that deletes the second print data generated from the print data generator, according to a print stop operation corresponding to a printed result according to the first print data.

3. The printing system of claim 1,
wherein the printing instruction apparatus further includes
a print data controller that generates at least one print job corresponding to the print request, and a display that displays at least one print job generated from the print data controller.

4. The printing system of claim 1,
wherein the printing instruction apparatus further includes
a print data controller that generates at least one print job corresponding to the print request, and
a display that displays a predetermined icon representing generation of the print job in the print data controller.

5. The printing system of claim 1,
wherein the printing instruction apparatus further includes
a storage that stores the second print data generated from the print data generator.

6. The printing system of claim 1, wherein the printing instruction apparatus is a personal computer.

7. The printing system of claim 6, wherein a plurality of the personal computers are connected to the printing apparatus.

8. A printing instruction apparatus which is connected to a printing apparatus, comprising:
a print data generator that generates first print data corresponding to document data of a first copy in document data and second print data corresponding to document data of second and subsequent copies in the document data, according to a print request for multiple copies of the document data; and
a transmitter that transmits the generated first print data to the printing apparatus,
wherein the transmitter transmits the generated second print data to the printing apparatus and instructs printing of the second print data in the printing apparatus, according to a print execution operation corresponding to a printed result in the printing apparatus according to the first print data.

9. A printing method in a printing system in which a printing instruction apparatus and a printing apparatus are connected with each other, the printing method comprising:
causing the printing instruction apparatus,
to generate first print data corresponding to document data of a first copy in document data and second print data corresponding to document data of second and subsequent copies in the document data, according to a print request for multiple copies of the document data, and
to transmit the generated first print data to the printing apparatus;
causing the printing apparatus,
to receive the transmitted first print data,
to perform printing according to the received first print data, and to receive a print execution operation corresponding to a printed result according to the first print data;
causing the printing instruction apparatus to transmit the generated second print data to the printing apparatus according to the print execution operation; and
causing the printing apparatus to perform printing according to the transmitted second print data.
